(19) United States
(12) Patent Application Publication
(10) Pub. No.: US 2025/0139559 A1
(43) Pub. Date: May 1, 2025

(54) OPERATIONS PROGRESS PREDICTION, OUTPUT, AND CONTROL

(71) Applicant: Deere & Company, Moline, IL (US)

(72) Inventors: Timothy MARQUIS, Clive, IA (US); Dylan J. ROTH, Kyle, TX (US); Ryan KIRK, Urbandale, IA (US); Kelly SIKKEMA, Brookline, MA (US); Noel W. ANDERSON, Fargo, ND (US)

(21) Appl. No.: 18/882,435

(22) Filed: Sep. 11, 2024

Related U.S. Application Data
(60) Provisional application No. 63/594,557, filed on Oct. 31, 2023.

(51) Int. Cl. G06Q 10/0639

(52) U.S. Cl. CPC G06Q 10/0639

(57) ABSTRACT

A computer implemented method comprises obtaining an operational strategy input identifying an operational strategy, obtaining a first progress perspective selection input identifying a progress perspective selection, obtaining historical data, and obtaining forecast data. The computer implemented method further comprises generating a first output including first performance perspective data based on the historical data, the forecast data, the first operational strategy, and the first progress perspective selection. The computer implemented further comprises generating a control signal to control a user associated system based on the first output.

### CROSS-REFERENCE TO RELATED APPLICATION

The present application is based on and claims the benefit of U.S. provisional patent application Ser. No. 63/594,557, filed Oct. 31, 2023, the content of which is hereby incorporated by reference in its entirety.

### FIELD OF THE DESCRIPTION

The present description relates to operations, such as off-road operations. More specifically, the present description relates to operation progress prediction, output, and control.

### BACKGROUND

There are many types of off-road operations, such as agricultural operations, construction operations, turf management operations, forestry operations, as well as other types of off-road operations. In some examples, a job or a season (e.g., agricultural season), can include multiple different operations occurring at the same time or at different times, or both. For example, an agricultural season (e.g., growing season) may stretch from a period of time between of a last killing frost in spring to a first killing frost in fall. In other examples, an agricultural season May stretch across different periods of time (e.g., end of harvest previous year to end of harvest next year, etc.). However a season is defined, it may consist of multiple operations, including multiple different operations, occurring simultaneously or successively, or both. For instance, during the course of an agricultural season, various different operations may be undertaken, such as tillage, planting, product application (e.g., spraying or spreading product such as fertilizer, pesticide, herbicide, etc.), water application, harvesting, as well as others. An agricultural season may stretch 100 days or more, and operations may be separated by days, weeks, or even months. An agricultural manager (e.g., farmer, etc.) needs to plan, schedule, and implement the various operations in an attempt to efficiently grow and harvest crop.

The discussion above is merely provided for general background information and is not intended to be used as an aid in determining the scope of the claimed subject matter.

### SUMMARY

A computer implemented method comprises obtaining an operational strategy input identifying an operational strategy, obtaining a first progress perspective selection input identifying a progress perspective selection, obtaining historical data, and obtaining forecast data. The computer implemented method further comprises generating a first output including first performance perspective data based on the historical data, the forecast data, the first operational strategy, and the first progress perspective selection. The computer implemented method further comprises generating a control signal to control a user associated system based on the first output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example operations computing system architecture.

FIG. 2 is a block diagram of example selections and example outputs, in more detail.

FIG. 3 is a block diagram of example mobile work machines and example computing systems, of operations computing system architecture, in more detail.

FIG. 4 is a block diagram showing one example user interface.

FIGS. 5A-5B are pictorial illustrations showing example user interfaces.

FIGS. 6A-6B are pictorial illustrations showing example user interfaces.

FIG. 7 is a pictorial illustration showing one example user interface.

FIG. 8 shows a flow chart illustrating one example of operation of operations computing system architecture.

FIG. 9 is a block diagram showing one example of items of an agricultural computing system architecture in communication with a remote server architecture.

FIGS. 10-12 show examples of mobile devices that can be used in an operations computing system architecture.

FIG. 13 is a block diagram showing one example of a computing environment that can be used in an operations computing system architecture.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

Users (e.g., agricultural users) tasked with managing operations are faced with making a number of decisions throughout the course of a job or a season. Often, users must make such decisions quickly and without time or resources for significant consideration. Such decisions can include whether to perform operations, the timing of operations, how to deploy resources to execute operations, and how to set machine settings for controlling a machine during an operation. Often, a user makes these decisions in order to optimize one or more performance metrics (e.g., quality, profit, time to complete, etc.).

It can be difficult for users to determine how well an operation or how well a job or a season is progressing, relative to end goals, during the course of the operation, job, or season. Additionally, conditions can change throughout the course of an operation, a job, or a season. It can be difficult for users to determine how a current plan will perform given the changing conditions, to determine how a possible adjustment to the plan will perform, or to determine what adjustments can be made to account for the changing conditions.

The present discussion proceeds, in some examples, with respect to systems that generate outputs indicative of progress of one or more operations, one or more jobs or one or more seasons, can further indicate one or recommend operational plan adjustments for adjusting the execution of the one or more operations, the one or more jobs or the one or more seasons.

It will be understood that while various examples detailed herein proceed in the context of agricultural operations and agricultural work machines the systems and methods described herein are applicable to and can be used in various other types of off-road operations and off-road machines, such as, but not limited to, construction operations and construction work machines, turf management operations and turf management machines, and forestry operations and forestry machines.

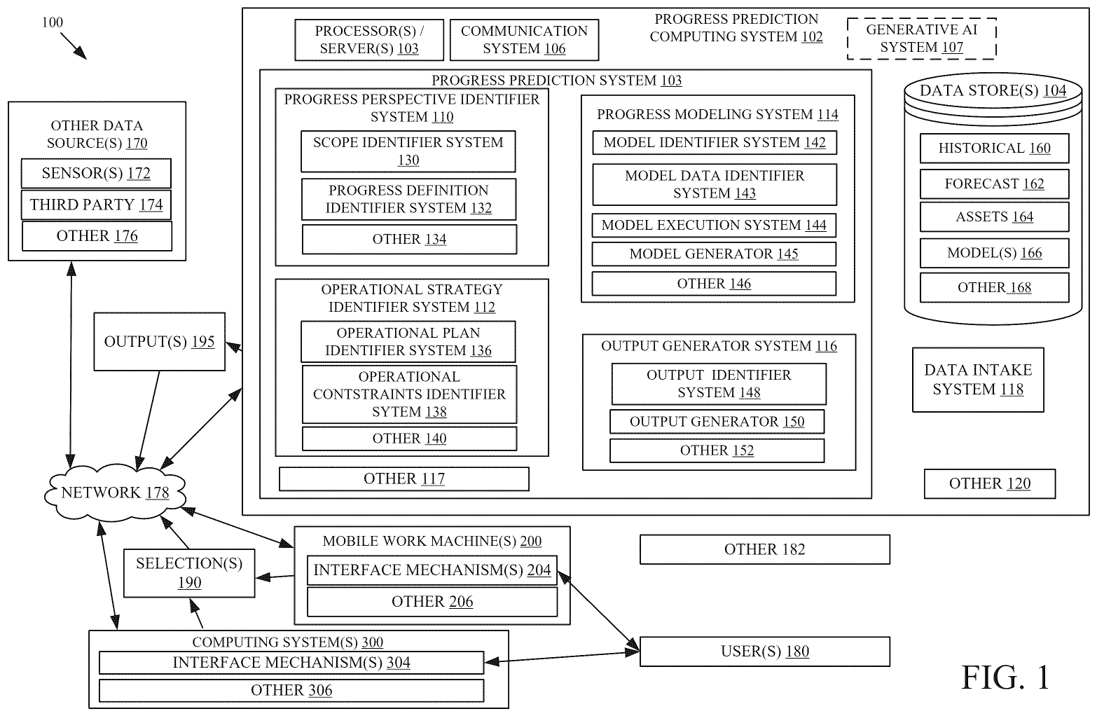

FIG. 1 is a block diagram of one example of an operations computing system architecture 100 including a progress prediction computing system 102, one or more user associated systems including one or more mobile work machines 200 and one or more user associated computing systems 300, and can include various other items 182 as well. Operations computing system architecture 100 can include various other items 182 as well. It can be seen that mobile work machines 200 and user associated computing systems 300 can include, among other things, user interface mechanisms 204 and 304, respectively. User interface mechanisms 112 can generate user interfaces for interaction by one or more users 180. A user 180 can interact with a user interface in order to control and manipulate progress prediction computing system 102, a mobile work machine 200, or a user associated computing system 300. As illustrated, the items of operations computing system architecture 100 can be connected to one another directly over one or more networks 178. Networks 178 can include a wide area network (WAN), a local area network (LAN), a Wi-Fi network, a near field communication network, a cellular communication network, a controller area network (CAN), or an of a wide variety of other networks or combinations of networks. Before providing a more detailed description of the operation of operations computing system architecture 100, a description of some of the items in operations computing system architecture 100, and their operation, will first be provided.

Progress prediction computing system 102 includes one or more processors or servers 103, one or more data stores 104, communication system 106, progress perspective identifier system 110, operational plan identifier system 112, progress modeling system 114, output generator system 116, data intake system 118, and can include various other items and functionality 120.

It will be understood that the one or more processors or servers 103 can include various processing units, including central processing units (CPUs) and graphic processing units (GPUs).

Communication system 106 provides for communication between items of progress prediction computing system 102 as well as between progress prediction computing system 102 and other items of operations computing system architecture 100. Communication system 106 can include wired communication circuitry or wireless communication circuitry, or both, as well as wired communication components or wireless communication components, or both. In some examples, communication system 106 can be a cellular communication system, a system for communication over a wide area network (WAN), a system for communication over a local area network (LAN), a system for communication over a controller area network (CAN), such as a CAN BUS, a system for communication over a near field communication network, or a system for communication over any of a wide variety of other networks, or a system for communication over a combination of the previously described networks. Communication system 106 can include a system that facilitates downloads or transfers of information to and from a secure digital (SD) card or a universal serial bus (USB) card, or both.

Data stores 104, themselves, include historical data 160, forecast data 162, assets data 164, one or more models 166, and can include various other data 168.

Data intake system 118 obtains (receives or retrieves) the data, via communication system 106, and stores the data in data stores 104.

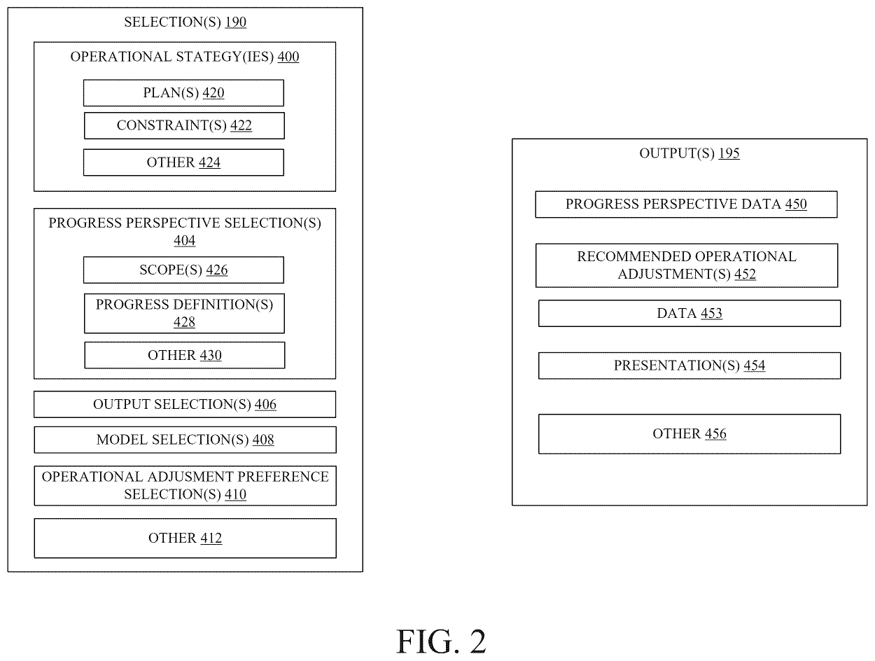

It will be understood that the data in data stores 104 can be obtained by progress prediction computing system 102 in various ways. For example, the data can be obtained by user input, such as a user input provided by a user 180 via interface mechanisms 204 or 304, or both. The data can be obtained from mobile work machines 200. For instance, mobile work machines 204 can include one or more sensors (as shown in FIG. 2) that can detect various characteristics and generate sensor data indicative of the detected characteristics. The data can be obtained from various other data sources 170 such as sensors 172, third party data sources 174, as well as various other sources 176. Sensors 172 can be sensors disposed on other types of machines, such as satellites, other aerial vehicles, or ground vehicles that are not owned by user 180. Sensors 172 can be sensors placed at the worksite but not disposed on a mobile work machine 200. For instance, sensors 172 can include sensors placed in the ground or stationed at one or more fields. Sensors 172 can include various other types of sensors. Third party data sources 174 can include the manufacturer, service providers (e.g., product companies, such as seed companies, fertilizer companies, pesticide companies, herbicide companies, etc.), experts (e.g., scientific research bodies, such as universities or other organizations), government bodies (e.g., USGS, USDA, National Weather Service, etc.), as well as various other third parties.

Historical data 160 can include a variety of historical data, including historical weather data, historical crop data, historical worksite data, historical operation data, historical sensor data, historical productivity data, as well as various other historical data. It will be understood that historical data includes data from one or more previous operations, jobs or seasons and include data from a previous time in a current operation, job or season.

Historical weather data can include various data indicative of historical weather characteristics such as historical temperature data, historical precipitation data, historical wind data, historical humidity data, historical sunlight (e.g., sunlight intensity, etc.) data, as well as various other historical weather data indicative of various other historical weather characteristics.

Historical crop data can include various data indicative of historical crop characteristics, such as historical crop genotype data, historical crop planting data (e.g., population, spacing, depth, etc.), historical crop growth data, historical crop yield data, historical crop constituents data, as well as various other historical crop data indicative of various other historical crop characteristics.

Historical worksite data can include various data indicative of historical worksite characteristics, such as historical worksite boundary data, historical worksite topography data, historical soil characteristic (e.g., soil moisture, soil type, soil nutrients, soil composition, soil compaction, etc.) data, as well as various other historical worksite data indicative of various other historical worksite characteristics.

Historical operation data can include various data indicative of historical operation characteristics, such as historical operation type data, historical operation location data, historical operation timing data, historical operation parameters data, as well as various other historical operation data indicative of various other historical operation characteristics.

Historical sensor data can include various data indicative of historical characteristics detected by sensors (e.g., sensors on mobile work machines 200, sensors 172, etc.).

Historical productivity data can include various data indicative of historical performance characteristics, such as historical time to complete data, historical costs data, historical profits data, historical yield data, historical losses data, historical quality data, as well as various other historical productivity data indicative of various other historical performance characteristics. Additionally, the historical productivity data may be categorized by machine or by operator, or both.

Forecast data 162 can include a variety of forecast data, including forecast weather data, forecast worker availability data, forecast equipment availability data, as well as various other forecast data. It will be understood that forecast data is predictive data.

Forecast weather data can include various data indicative of forecast weather characteristics such as forecast temperature data, forecast precipitation data, forecast wind data, forecast humidity data, forecast sunlight (e.g., sunlight intensity, etc.) data, as well as various other forecast weather data indicative of various other forecast weather characteristics.

Forecast worker availability data can include various data indicative of worker availability, such as forecast worker availability data that indicates the workers that will be available to work and when the workers will be able to work, as well as various other forecast worker availability data indicative of various other worker availability characteristics.

Forecast equipment availability data can include various data indicative of equipment availability characteristics, such as forecast equipment availability data that indicates the types of equipment that will be available for work, the number of equipment that will be available for work, when equipment will be available for work, as well as various other forecast equipment availability data indicative of various other equipment availability characteristics.

Assets data 164 can include a variety of assets data including equipment assets data, worker assets data, worksite assets data, products assets data, resources assets data, as well as various other assets data.

Equipment assets data include various data indicative of equipment characteristics, such as equipment assets data that indicates the number of equipment, the types of equipment, the ratings of the equipment, cost of operation of equipment, as well as various other equipment assets data that indicates various other equipment characteristics. It will be understood that equipment assets data can include data relative to equipment of the particular user and data relative to equipment available to the user (e.g., equipment available to rent or purchase, such as equipment available to rent or purchase within a given distance of the user).

Worker assets data include various data indicative of worker characteristics, such as worker assets data that indicates the number of workers, the qualifications of the workers (e.g., equipment qualified to operate), cost of labor of the workers, as well as various other worker assets data that indicates various other worker characteristics. It will be understood that worker assets data can include data relative to workers of the particular user and data relative to workers available to the user (e.g., workers available to hire, such as workers available to hire within a given distance of the user).

Worksite assets data can include various data indicative of worksite characteristics, such as the location, size, and identifying information of the worksites, as well as various other worksite assets data that indicates various other worksite characteristics. It will be understood that worksite assets data can include data relative to worksite of the particular user and data relative to worksites available to user (e.g., worksites available to purchase or rent, such as worksites available to purchase or rent within a given distance of the user).

Product assets data can include various data indicative of product characteristics, such as the types of product, the amount of product, the cost of the product, as well as various other product assets data that indicates various other product characteristics. It will be understood that product assets data can include data relative to the products of the particular user and data relative to products available to user (e.g., products available to purchase, such as product available to purchase within a given distance of the user).

Resources assets data can include various data indicative of resources characteristics, such as the types of resources, the amount of resources, the cost of the resources, as well as various other resources assets data that indicates various other resources characteristics. It will be understood that resources assets data can include data relative to the resources of the particular user and data relative to resources available to user (e.g., resources available to purchase, such as resources available to purchase within a given distance of the user).

Models 166 are configured to receive one or more inputs and generate one or more outputs, for example, to receive one or more of historical data 160, forecast data 162, assets data 164, and other data 168 and generate an output, such as progress perspective data 160. Models can be preprocessed (e.g., pretrained or preset models) or models can be generated, such as generated in response to a user request. Models can be obtained from a third-party or can be preprocessed or generated by progress prediction computing system 102. Models 166 can include without limitation, equations, functions (e.g., regressions, etc.), empirical correlations, statistics, tables, matrices, and the like. In other examples, models can include symbols, knowledge bases, and logic such as rule-based systems. Some models are hybrid, utilizing both mathematics and logic. Some models may include random, non-deterministic, or unpredictable elements. Some models May include networks of data values such as neural networks. Models 166 can include, without limitation, crop growth models, crop senescence models, crop ripening models, crop dry down models, soil trafficability models, soil compaction susceptibility models, soil carbon sequestration models, equipment productivity models, worker productivity models, equipment availability models (e.g., maintenance and repair downtime, unscheduled downtime, etc.), worker availability models, off-field crop handling models (e.g., highway transport models, crop dryer throughput models, storage acceptance throughput models, ginning models, etc.), These are just some examples of models.

Data stores 122 can include various other data 168 including, but not limited to, one or more selections 190, outputs 195, computer executable instructions that are executable by one or more processors or servers 103 to implement other items or functionalities of progress prediction computing system 102, as well as various other data. It will be understood that data stores 104 can include different forms of data stores, for instance one or more of volatile data stores (e.g., Random Access Memory (RAM)) and non-volatile data stores (e.g., Read Only Memory (ROM), hard drives, solid state drives, etc.).

Progress prediction computing system 102 receives one or more selections 190 and generates one or more outputs 195 based, at least in part, on the one or more selections 190. Discussion will now briefly proceed at FIG. 2. FIG. 2 is a block diagram illustrating one example of selections 190 and outputs 195 in more detail.

As shown in FIG. 2, selections 190 can include one or more operational strategies 400, one or more progress perspective selections 404, one or more output selections 406, one or more model selections 408, one or more operational adjustment preference selections 410, and can include various other items 412.

Operational strategies 400 can include one or more plan(s) 420, one or more constraint(s) 422, and can include various other items 424.

Plans 420 define various operational strategy parameters for a planned operation or a planned job or season. Plans 420 can define planned timing and location of one or more operations, planned machine settings and prescriptions for each of the one or more operations, planned machine distributions for each of the one or more operations, and planned operator assignments for each of the one or more operations. Plans 420 can also define planned goals, such as outcomes to maximize (e.g., maximize profit, maximize yield, maximize revenue, etc.) or outcomes to minimize (e.g., minimize carbon dioxide total or per unit produced, minimize loss, etc.), or both. Plans 420 can define a complete by date goal. Plans 420 can define planned usage (e.g., do not use overtime hours, use overtime hours, only use owned equipment, can use leased, borrowed, or buy and use upgraded equipment, etc.). Plans 420 can define repair strategies (e.g., fix-on-fail, condition-based repair, etc.). Plans 420 can define various other operational strategy parameters.

Constraints 422 define operational strategy constraints or limits not to be exceeded. Constraints 422 can include minimums, maximums, or deadlines not to be exceeded. Constraints 422 can define, without limitation, maximum carbon dioxide total or per unit produce, completion deadline, earliest start date, minimum profit, maximum point soil compaction, maximum aggregate soil compaction, average soil compaction, minimum soil erosion potential, as well as various other constraints (or limits).

Progress perspective selections 404 can include one or more scope(s) 426, one or more progress definition(s) 428, and can include various other items 430.

Scope(s) 426 define the operation or operations or job or jobs or season or seasons for which progress perspective data is sought. For example, scopes 426 can define that progress perspective data is sought for one or more operations (e.g., tilling/cultivating, planting, spraying, spreading, irrigation, harvesting, etc.), occurring at the same time or at different times and occurring at the same worksite or at different worksites. Scopes 426 can define that progress perspective data is sought for one or more jobs or seasons, such as the progress of a job or of multiple jobs, or the progress of a season or of multiple seasons, for a worksite or multiple worksites.

Progress definitions 428 define progress, or, more particularly, that which the progress of is being tracked. Some examples of progress definitions 428, without limitation, include completion, area completed, crop growth stage and projected maturity, revenue harvested, crop volume/mass harvested or grazed, profit harvested, harvestable bushels planted, loss, loss prevented, incremental yield gain, as well as various other progress definitions.

In some examples, the way in which outputs 195 are presented can be customized or preselected. In other examples, the way in which outputs 195 are presented is determined by progress prediction computing system 102. Output selections 406 define parameters of how progress perspective data is to be presented, such as defining the type of presentation (e.g., visual, such as a display, or audible, etc.), as well as elements of the presentation (e.g., graphs, labels, titles, scales, grid lines, colors, patterns, textures, point symbols, etc.). In some examples, there may be a number of presentation templates, from which a template can be selected. Output selections 406 can further define whether progress prediction computing system 102 is to provide alerts or annotations, or both. Output selections 406 can further define whether progress prediction computing system 102 is to provide recommend operational adjustments.

In some examples, the model(s) 166 to be used by progress prediction computing system 102 can be selected by the entity (e.g., user 180, machine 200, computing system 300, etc.) requesting outputs 195. Model selections 408 may thus define which model(s) 166 are to be used by progress prediction computing system 102 in generating outputs 195. In other examples, progress prediction computing system 102 determines which models 166 are to be used.

In some examples, progress prediction computing system 102 provides, as an output, one or more recommended operational adjustments. Operational adjustment preference selections 410 thus define which one or combination of recommended operational adjustments are preferred to be implemented.

Outputs 195 can include progress perspective data 450, one or more recommended operational adjustments 452, data 453, one or more presentation(s) 454, and can also include various other items 456.

Progress perspective data 450 includes progress information relative to progress perspective selections 404. Progress perspective data 450 can include progress of an operation or of multiple operations, the progress of a job or of multiple jobs, or the progress of a season or multiple seasons, relative to progress definitions 428. Additionally, progress perspective data 450 includes progress information indicative of progress so far completed as well as information indicative of a prediction of upcoming progress, which can include a prediction of when upcoming progress will occur and when progress will be complete.

Recommended operational adjustments 452 can include recommended adjustments to an operational strategy 400. Recommended operational adjustments can include adjustments to plans 420 or constraints 422, or both. Recommended operational adjustments can include adjustments to operation timing, operations to take place, machine settings, prescriptions, machine distributions, worker (or operator) assignments, machine use, worker use, repair strategies, complete by dates, as well as various other operational strategy parameters and constraints.

Data 453 includes one or more (or portions of one or more) of historical data 160, forecast data 162, assets data 164, models 166, and other data 168.

Presentations 454 can include displays or audible outputs, or both, that present progress perspective data 450 or recommend operational adjustments 452, or both, as well, in some examples, data 453, which can be presented on interface mechanisms (e.g., 204 or 304, or both). Alternatively, presentations 454 can include instructions, useable by interface mechanisms (e.g., 204 or 304, or both) for presenting (e.g., via display or audible output, or both) progress perspective data 450 or recommended operational adjustments 452, or both, as well, in some examples, data 453.

It will be understood that selections 190 can be provided by a user 180, such as through interaction(s) with an interface mechanism (e.g., 204 or 304, or both) or can be provided by a machine (e.g., 200 or 300, or both), or both.

Discussion now returns to FIG. 1.

As illustrated in FIG. 1, progress prediction computing system 102 receives one or more selections 190 and generates one or more outputs 195.

Progress perspective identifier system 110 illustratively identifies progress perspective selections 404. Progress perspective identifier system 110 illustratively includes scope identifier system 130, progress definition identifier system 132, and can include other items 134. Scope identifier system 130 identifies scopes 426. Progress definition identifier system 132 identifies progress definitions 132. Other items 134 can identify other items 428.

Operational strategy identifier system 112 illustratively identifies operational strategies 400. Operational strategy identifier system 112 illustratively includes operational plan identifier system 136, operational constraints identifier system 138, and can include other items 140. Operational plan identifier system 136 identifies plans 420. Operational constraints identifier system 138 identifies constraints 122. Other items 140 can identify other items 424.

Output generator system 116 illustratively generates outputs 195 that include progress perspective data 450 and, in some examples, recommended operational adjustments 452 generated by progress modeling system 114 or data 453, or both, and can include presentations 454 that present or provide instructions for presenting progress perspective data 450 and, in some examples, recommended operational adjustments 452 or data 453, or both. Output generator system 116 illustratively includes output identifier system 148, output generator 150, and can include other items 152 as well. Output identifier system 148 identifies output selections 406. Output generator 150 generates outputs 195.

Progress modeling system 114 illustratively executes or generates models to generate progress perspective data 450 and, in some examples, recommended operational adjustments 452, based on operational strategies 400 identified by operational strategy identifier system 112, progress perspective selections 404 identified by progress perspective identifier system 110, and in some examples, output selections 406 identified by output identifier system 148 or model selections 408 identified by model identifier system 143, or both. For example, where an output selection 406 indicates that recommended operational adjustments 452 are to be provided, then progress modeling system 114 executes or generates models 166 to provide recommended operational adjustments 452. In some examples, recommended operational adjustments 452 may be provided by default, in which case, progress modeling system 114 executes or generates models 166 to provide recommended operational adjustments 452 by default (i.e., with output selections 406 indicating desire for recommended operational adjustments 452). In some examples, progress modeling system 114 executes or generates models 166 identified by model selections 408. In other examples, progress modeling system 114 determines which models 166 to execute or generate based on other information, such as operational strategies 400 or progress perspective selections 404, or both.

Progress modeling system 114 illustratively includes model identifier system 142, model data identifier system 143, model execution system 144, model generator 145, and can include various other items 146 as well.

In one example, model identifier system 142 illustratively identifies model selections 408 and identifies which model(s) 166 to execute or generate based on model selections 408. In another example, model identifier system 142 identifies which model(s) 166 to execute or generate based on operational strategies 400 and progress perspective selections. Further, in either example, model identifier system 142 can identify which model(s) 166 to execute or generate based on output selections 406 (e.g., output selections 406 indicating whether recommended operational adjustments 452 are to be provided).

Model data identifier system 143 illustratively identifies which data to provide as input(s) to the model(s) identified by model identifier system 143 or which data to provide for the generation of the model(s) identified by model identifier system 143, or both, based on the model(s) identified by model identifier system 143 and interacts with data stores 104 (e.g., via communication system 106) to obtain one or more items of data, such as one or more of historical data 160, forecast data 162, and assets data 164.

Where one or more preprocessed models are identified by model identifier system 142, model execution system 144 interacts with data stores 104 (e.g., via communication system 106) to obtain the one or more preprocessed models 166 and executes the one or more preprocessed models 166, by providing the corresponding model input data identified by model data identifier system 143, to the one or more preprocessed models 166 which, in turn, provide, as output(s) progress perspective data 450 or one or more recommended operational adjustments 452, or both.

Where one or more models are to be generated, as identified by model identifier system 142, model generator 145 generates one or more models 166 based on the data identified by model data identifier system 143. The generated models 166, in turn, provide, as output(s), progress perspective data 450 or one or more recommended operational adjustments 452, or both.

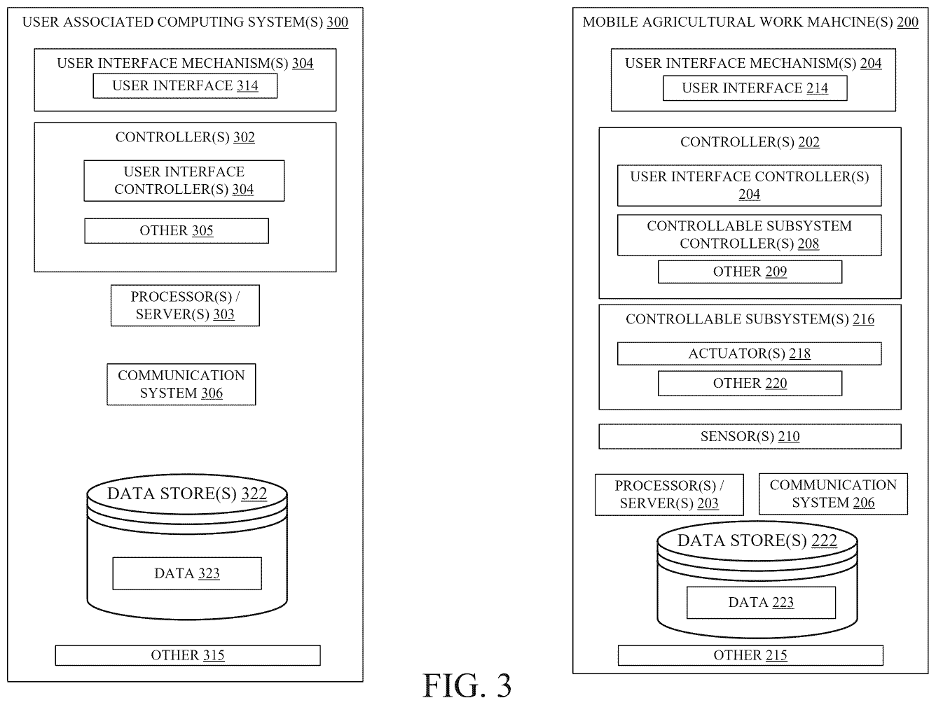

Output generator system 116, as previously discussed, generates one or more outputs 195. Outputs 195 can provided to one or more user associated systems, such as one or more computing systems 300 or one or more mobile work machines 200, or both, and can be used to control the one or more user associated systems. For example, interface mechanisms 204 or 304 may be controlled to present (e.g., display, audibly present, both, etc.) the outputs 195 (or one or more items of information from the outputs 195) to one or more users 180. Alternatively, or additionally, the operation of one or more mobile work machines 200 may be controlled based on the outputs 195, for instance, one or more controllable subsystems (e.g., 216 shown in FIG. 3) May be controlled based on outputs 195.

It will be understood that in some examples, progress prediction system 102 may include, or otherwise utilize, a generative artificial intelligence (AI) system (or model), such as large language model (LLM), as illustrated by dashed box 107. Generative AI system 107 may be executed or implemented by one or more processors or servers 103, and may implement, execute, or prompt the functionality of one or more other items shown in progress prediction computing system 102. Further, generative AI system 107 may interact with other items (e.g., computing systems 200 or mobile work machines 200, or both) of computing system 100 or with users 180 (via computing systems 300 or mobile work machines 200, or both) over network 178.

It will be understood that while the example shown in FIG. 1 illustrates items being distributed across operations computing system architecture 100 in a particular way, in other examples, one or more of the items shown in FIG. 1 can be, alternatively or additionally, located elsewhere. For example, but not by limitation, progress prediction computing system 102, or items thereof, may be disposed on a user associated system, such as on a computing system 300 or on a mobile work machine 200, or both. Thus, it will be understood that the items in operations computing system architecture 100 can be distributed in various ways, including ways that differ from the example shown in FIG. 1.

FIG. 3 is a block diagram showing mobile work machines 200 and agricultural computing systems 300 in more detail.

Computing systems 300 can be a wide variety of different types of systems, or combinations thereof. For example, computing systems 300 can be computing systems such as mobile devices (e.g., smart phones, laptops, tablets, as well as other types of mobile devices), personal computers (e.g., desktops), a remote network, a farm manager system, a vendor system, or a wide variety of other computing systems.

Mobile work machines 200 can be a wide variety of different types of off-road mobile work machines. For example, mobile work machines 200 can be mobile agricultural machines, such as mobile agricultural harvesting machines, mobile agricultural tillage machines, mobile agricultural planting machines, mobile agricultural product application machines (e.g., fluid sprayers, solid material applicators (e.g., spreaders), etc.), mobile agricultural support machines (e.g., grain carts, grain trucks, tender vehicles, etc.), as well as various other types of mobile agricultural work machines. Mobile work machines 200 can also be mobile construction (or earth moving) machines (e.g., dump trucks, backhoes, excavators, loaders, dozers, graders, scrapers, skid steers, etc.), mobile turf management machines (e.g., mowers, rake machines, shredder machines, aeriation machines, etc.), or mobile forestry machines (e.g., forestry harvesters, feller bunchers, shovel loggers, skidders, kuckleboom loaders, etc.). In some examples, mobile work machines 200 include a towing vehicle (e.g., a tractor, truck, etc.) and a towed implement. In some examples, mobile work machines 200 are self-propelled (i.e., the machine that carries the implement also includes propulsion means). In some examples mobile work machines 200 include components (e.g., tools, implements, etc.) that engage a worksite or engage with material at the worksite, or both.

As shown in FIG. 3, mobile work machines 200 include one or more user interface mechanisms 204 and computing systems 300 include one or more user interface mechanisms 304. Users 180 may interact with or operate, or both, mobile work machines 200 through user interface mechanisms 204 or interact with or operation, or both computing systems 300 through user 304, or both. User interface mechanisms 204 and 304 can include joysticks, levers, a steering wheel, linkages, keyboards, point and click devices (e.g., a mouse, etc.), pedals, buttons, wireless devices (e.g., mobile computing devices, etc.), dials, keypads, a display screen including user interactable display elements (such as icons, buttons, windows, menus, etc.), a microphone and speaker (where speech recognition and speech synthesis are provided), among a wide variety of other types of user interface mechanisms. In some examples, user interface mechanism 204 includes a display screen controllable to display a user interface 214, such as a graphical user interface (GUI). In some examples, a user interface mechanism 304 includes a display screen controllable to display a user interface 314, such as a graphical user interface (GUI). In some examples, the display may be touch sensitive, in which case users may interact with the display using touch gestures. The examples described above are provided as illustrative examples and are not intended to limit the scope of the present disclosure. Consequently, other types of user interface mechanisms may be used and are within the scope of the present disclosure.

As shown in FIG. 3, mobile work machines 200 include a communication system 206 and computing systems 300 include a communication system 306. Communication system 306 provides for communication between items of a computing system 300 as well as between a computing system 300 and other items of operations computing system architecture 100. Communication system 206 provides for communication between items of a mobile work machine 200 as well as between a mobile work machine 200 and other items of operations computing system architecture 100. Communication system 206 or communication system 306, or both, can include wired communication circuitry or wireless communication circuitry, or both, as well as wired communication components or wireless communication components, or both. In some examples, communication system 206 or communication system 306, or both, can be a cellular communication system, a system for communication over a wide area network (WAN), a system for communication over a local area network (LAN), a system for communication over a controller area network (CAN), such as a CAN BUS, a system for communication over a near field communication network, or a system for communication over any of a wide variety of other networks, or a system for communication over a combination of the previously described networks. Communication system 206 or communication 306, or both, can include a system that facilitates downloads or transfers of information to and from a secure digital (SD) card or a universal serial bus (USB) card, or both.

Mobile work machines 200 can include one or more processors or servers 203 and one or more data stores 222. Computing systems 300 can include one or more processors or servers 303 and one or more data stores 322. Data stores 222 include various data 223. Data stores 322 include various data 323. Data 223 or data 323, or both, can include some or all of selections 190, outputs 195, historical data 160, forecast data 162, assets data 164, models 166, other data 168, as well as various other data. Data 223 can include computer executable instructions that are executable by one or more processors or servers 203 to implement other items or functionalities of mobile work machines 200, as well as various other data. Data 323 can include computer executable instructions that are executable by one or more processors or servers 303 to implement other items or functionalities of computing systems 300, as well as various other data. It will be understood that data stores 222 or data stores 322, or both, can include different forms of data stores, for instance one or more of volatile data stores (e.g., Random Access Memory (RAM)) and non-volatile data stores (e.g., Read Only Memory (ROM), hard drives, solid state drives, etc.).

Computing systems 300 can include one or more controllers 302 that are operable to generate control signals to control various items of computing systems 300. Controllers 302 include one or more user interface controllers 304 and can include various other controllers 305. User interface controllers 202 are operable to control user interface mechanisms 304, such as to control user interface mechanisms 304 to generate a user interface 314 based on an output 195, or to generate other presentations (e.g., audible outputs, etc.) based on an output 195, or both. Computing systems 300 can include various other items and functionality 315.

Mobile work machines 200 can include one or more controllers 202 that are operable to generate control signals to control various items of mobile work machines 200. Controllers 202 include one or more user interface controllers 204, one or more controllable subsystem controllers 208, and can include various other controllers 209. User interface controllers 204 are operable to control user interface mechanisms 204, such as to control user interface mechanisms 204 to generate a user interface 214 based on an output 195, or to generate other presentations (e.g., audible outputs, etc.) based on an output 195, or both. Controllable subsystem controllers 208 are operable to control controllable subsystems 216, for example based on an output 195 or based on user input (e.g., an operational adjustment preference selection 410 input by a user), with user interface mechanisms 204, or both.

Controllable subsystems 216 include one or more actuators 218 and can include various other items 220 as well. Actuators 218 are controllable to control operation of mobile work machines 200. Actuators 218 can include any of a variety of different types of actuators, including, but not limited to, electromechanical actuators, electrical actuators, hydraulic actuators, pneumatic actuators, as well as other types of actuators. Some examples of actuators 218 include motors, internal combustion engines, pumps, valves, hydraulic cylinders, pneumatic cylinders, linear actuators, as well as various other actuators. As discussed, actuators 218 are controllable to control operation of mobile work machines 200, for example to control travel speed, to control travel direction, to control operational speed of various components of mobile work machines 200, to control position of various components of mobile work machines 200, to control orientation (e.g., pitch, roll, and yaw) of various components of mobile work machines 200, to control state (e.g., on or off, opened or closed, etc.) of various components of mobile work machines 200, to control displacement of various components of mobile work machines 200, as well as to control various other operational parameters. It will be understood that controllable subsystems 216 may vary with the type of mobile work machine 200.

As shown, in FIG. 3, mobile work machines 200 can include one or more sensors 210. Sensors 210 can include any of variety of different types of sensors. Sensors 210 can detect characteristics of the worksite (e.g., topographic characteristics, soil characteristics, etc.), characteristics of material (crop and non-crop vegetation, etc.) at the worksite, characteristics of the environment of the worksite (e.g., weather characteristics, etc.), characteristics of the work machine (e.g., geographic position, speed, heading, pitch, roll, yaw, operational parameters, performance characteristics, etc.), as well as various other characteristics. As previously discussed, sensors 210 can be a data source to provide various data, including at least some of historical data 160 and assets data 164.

Mobile work machines 200 can include various other items or functionalities 215.

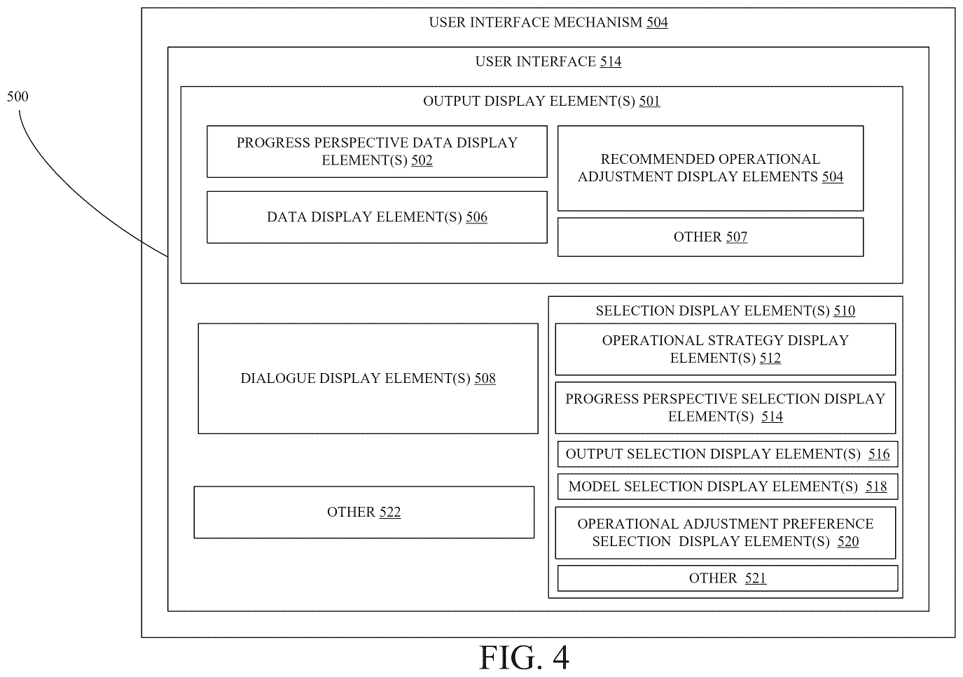

FIG. 4 is a block diagram showing one example of a user interface 514 or user, in more detail. User interface 514 can be displayed as a user interface 214 or as a user interface 314, or both. As illustrated in FIG. 3, user interface 514 is a graphical user interface (GUI) displayed on a display screen 500 of a user interface mechanism 504. Interface mechanism 504 in FIG. 4, comprises a computing device, such as a mobile device, a personal computer, an infotainment system, or another type of computing device having a display screen. Interface mechanism 504 in FIG. 4 could be a user interface mechanism 204 or a user interface mechanism 304, or both.

As illustrated in FIG. 4, user interface 514 includes one or more output display elements 501, dialogue display elements 508, selection display elements 510, and can include various other display elements 522 as well.

Output display elements 501 are display elements corresponding to an output 195, that is, are display elements that display information provided by an output 195. Output display elements 501 include one or more progress perspective data display elements 502, one or more recommended operational adjustment display elements 504, one or more data display elements 506, and can include various other display elements 507 as well.

Selection display elements 510 are display elements corresponding to selections and provide for display of selections and for user interaction to provide one or more selections 190. Selection display elements 510 operational strategy display elements 512, progress perspective selection display elements 514, output selection display elements 516, model selection display elements 518, operational adjustment preference selection display elements 520, and can include various other display elements 521 as well.

Progress perspective data display elements 402 display progress perspective data 450. Progress perspective data display elements 402 can include graphs (or elements of graphs), maps (or elements of maps), as well as various other computer generated images, depicting progress perspective data 450. Graphs can include line graphs, bar graphs/charts, pie charts, histograms, scatter plots, area charts, box plots, etc. Graphs can include various other types of graphs. Maps can include maps of one or more worksites and can include variable indicators (colors, patterns, values, etc.) that represent information, such as values of one or more variables, as well as legends that define what the indicators represent. The indicators can be georeferenced, that is, each indicator can be displayed at a location in the map image that corresponds to the position in the field to which the variable (represented by the indicator) corresponds. Progress perspective data display elements 502 can also include textual display elements (e.g., text boxes, etc.) that display words, letters, numbers, and other characters, or combinations thereof, in text form. Progress perspective data display elements 502 can include various other types of display elements.

Recommended operational adjustment display elements 504 display recommended operational adjustments provided by an output 195. Recommended operational adjustment display elements 504 can include images, such as prescription map images. The prescription map images can include prescription map images of one or more worksite and can include indicators (colors, patterns, values, etc.) that represent information, such as prescription values, as well as legends that define what the indicators represent. The prescription indicators can be georeferenced, that is, each prescription indicator can be displayed at a location in the map image that corresponds to the position of the information the prescription indicator represents in the worksite. The prescription values can include prescribed application rates, prescribed machine settings (e.g., speed, such as travel speed or operating speed of individual components, position (e.g., height, depth, or spacing of components), orientation, routes, as well as various other machine settings, as well as various other prescription values. Recommended operational adjustment display elements 504 can also include textual display elements (e.g., text boxes, etc.) that display words, letters, numbers, and other characters, or combinations thereof, in text form. Recommended operational adjustment display elements 504 can include various other types of display elements. In some examples, prescription display elements 404 may be user actuatable (e.g., by touch input) and actuation May act as user authorization for instituting the recommended operational adjustments 452 or may cause the user interface mechanism 501 to alter the interface 514 to generate a display of a menu that allows the user to institute the prescriptions.

Data display elements 506 display data 453 provided by an output 195. Data display elements 506 can include textual display elements (e.g., text boxes, etc.) that display words, letters, numbers, and other characters, or combinations thereof, in text form. Data display elements 506 can include graphs (or elements of graphs), maps (or elements of maps), as well as various other computer generated images, depicting data 453. Data display elements 506 can include various other types of display elements.

Dialogue display elements 508 comprise a dialogue interface area for providing for and displaying of dialogue between a user 180 and progress prediction computing system 102. In one example, dialogue display elements 508 includes an input field (text input field) display element, a software keyboard display element, an enter or send button display element, and a dialogue feed display field display element. A user 180 can interact (e.g., via touch input, etc.) with the software keyboard to input text (letters, numbers, other characters) to compose dialogue which is displayed for review in the input field display element. When a user wishes to submit a dialogue, the user can interact (e.g., via touch input, etc.) with the enter or send button display element. The submitted dialogue will be displayed in the dialogue feed display element. A response to the user submitted dialogue may be provided by progress prediction computing system 102 and the response can be displayed in the dialogue feed display element. User submitted dialogue and responses from progress prediction computing system 102 can be differentiated in the dialogue feed display element in various ways including by difference in color or position, or both. User submitted dialogue and responses can remain displayed in the dialogue feed display element and subsequent user submitted dialogue and responses can be displayed, in a feed-style manner, below previous user submitted dialogue and responses. In some examples, user interface mechanism 504 may support audible input and output, in which case, a user may, additionally, or alternatively, compose dialogue via audible speech and the responses from progress prediction computing system 102 may additionally, or alternatively, be output via audible speech. The dialogue display elements 508 may include a button or toggle to switch audible input and output functionality on and off.

Selection display elements 510 provide for user interaction (e.g., touch, audible, etc.) to provide one or more selections 190. Operational strategy display elements 512 provide for user interaction to provide one or more operational strategies 400. Progress perspective display elements 514 provide for user interaction to provide one or more progress perspective selections 404. Output selection display elements 516 provide for user interaction to provide one or more output selections 406. Model selection display elements 518 provide for user interaction to provide one or more model selections 408. Operational adjustment preference selection display elements provide for user interaction to provide one or more model selections. Display elements 510 can include an input field (text input field) display element, a software keyboard display element, an enter or send button display element. A user 180 can interact (e.g., via touch input, etc.) with the software keyboard to input text (letters, numbers, other characters) to compose dialogue which is displayed for review in the input field display element. Display elements 510 can additionally, or alternatively, include various other types of display elements such as buttons, menus, as well as various other types of display elements. In some examples, user interface mechanism 504 may support audible input and output, in which case, a user may, additionally, or alternatively, provide selections 190 via audible speech. The selection display elements 510 may include a button or toggle to switch audible input and output functionality on and off.

Additionally, it will be understood that in some examples selections 190 may be input as dialogue via dialogue display elements 508. In other examples, selections 190 may be input through selection display elements 510. In other examples, selections 190 may be input as dialogue via dialogue display elements 508 or through selection display elements 510, or both. In yet other examples, some selections 190 may be input additionally, or alternatively, through interaction with other display elements, for example, operational adjustment preference selections may be provided through user interaction with recommended operational adjustment display elements 504.

It will be understood that interface 514, as shown in FIG. 3, can include various types of display elements such as buttons, breadcrumbs, checkboxes, dropdowns, forms, icons, input fields, toggles, steppers, tags, tab bars, sidebars, search fields, radio buttons, progress bars, pickers, notifications, paginations, menus, modals, loaders, feeds, carousels, cards, accordions, as well as various other types of display elements.

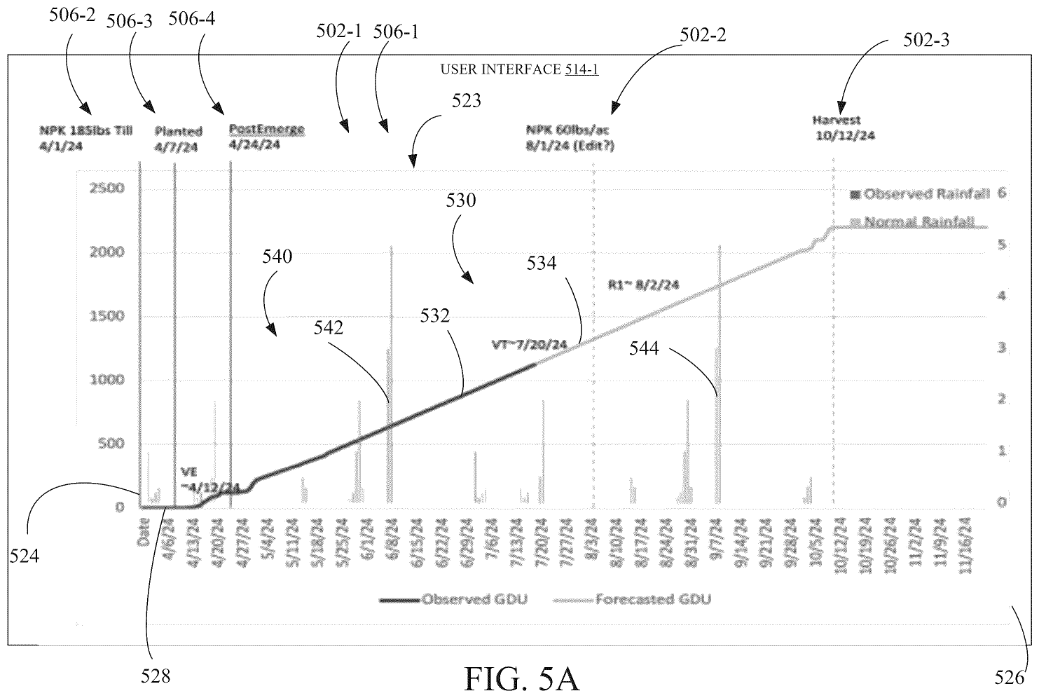

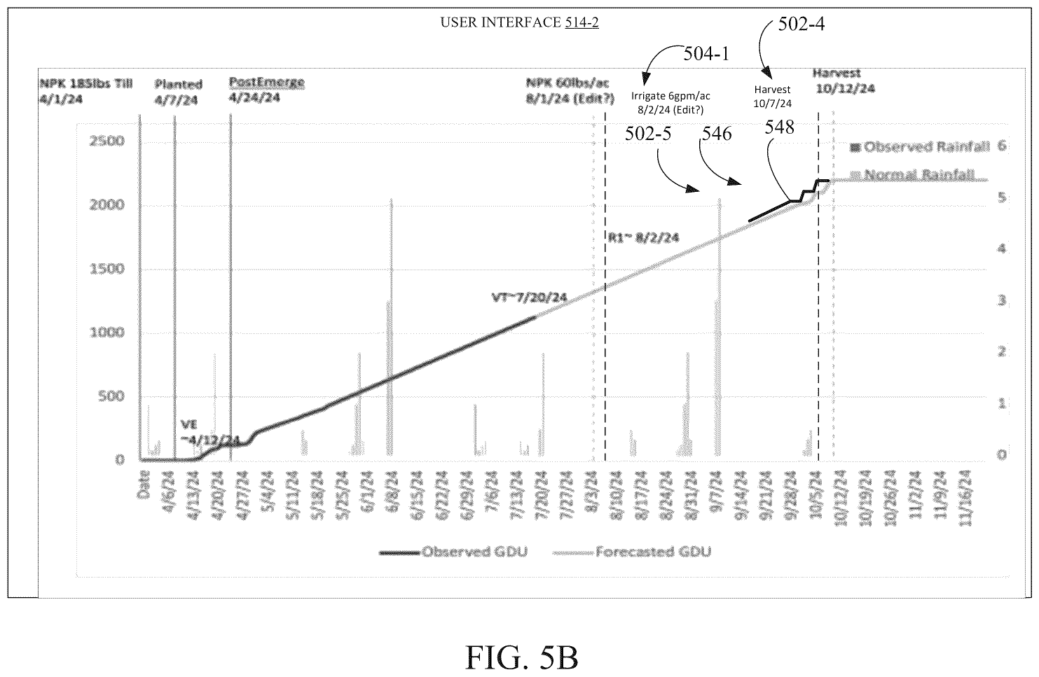

FIG. 5A shows a pictorial illustration of one example user interface 514 (illustratively 514-1). Interface 514-1 includes example progress perspective data display elements 502 (illustratively 502-1, 502-2, and 502-3) and example data display elements 506 (illustratively 506-1, 506-2, 506-3, and 506-4).

Generally, user interface 514-1 illustrates historical and predicted progress of crop growth over the course of a season and provides further context with display of historical and forecast weather data (e.g., precipitation data), as well as historical and predicted operations.

As illustrated in FIG. 5A, progress perspective data display element 502-1 and data display element 506-1 comprise a graph 523. Graph 523 is a combination graph, including a line graph (progress perspective data display element 502-1) and a histogram (data display element 506-1). Progress perspective data display element 502-1 further includes a y-axis 524 that provides a crop growth value scale (illustratively growing degree unit (GDU) value scale) and an x-axis 528 that provides a time scale (illustratively with date intervals). Data display element 506-1 further includes a y-axis 526 that provides a precipitation value scale (illustratively precipitation accumulation in inches) and x-axis 528. Progress perspective data display element 502-1 further includes a line display element 530 that includes a historical progress portion 532 and a predicted progress portion 534. Historical progress portion 532 illustrates the historical crop growth from a beginning of the season (illustratively from the date of tillage on Apr. 1, 2024 (4/1/24)) to a current time (or a last measured time), illustratively Jul. 18, 2024 (7/18/24). Predicted progress portion 534 illustrates a predicted crop growth throughout a remainder of the season (illustratively up to harvest time on Oct. 12, 2024 (10/12/24)). Data display element 506-1 further includes histogram bars 540 that include historical bars 542 and forecast bars 544. Historical bars 542 illustrate the historical precipitation accumulation from a beginning of the season (illustratively from the date of tillage on Apr. 1, 2024 (4/1/24)) to a current time (or last measured time), illustratively Jul. 18, 2024 (7/18/2024). Forecast bars illustrate a forecast precipitation accumulation throughout a remainder of the season (illustratively up to harvest time on Oct. 12, 2024 (10/12/24).

Data display element 506-2 comprises text “NPK 185 lbs Till Apr. 1, 2024” and a line 9 overlaying the graph 523 and disposed on the x-axis 528 at the interval representing the date Apr. 1, 2024 (4/1/24) to illustrate that a tillage operation, including application of NPK (nitrogen, phosphorus, and potassium) fertilizer product at 185 pounds an acre, was conducted on Apr. 1, 2024. Data display element 506-3 comprises text “Planted Apr. 7, 2024” and a line overlaying the graph 523 and disposed on the x-axis 528 at the interval representing the date Apr. 7, 2024 (4/7/24) to illustrate that planting was completed on Apr. 7, 2024. Data display element 506-4 comprises text “PostEmerge Apr. 24, 2024” and a line overlaying the graph 523 and disposed on the x-axis 528 at the interval representing the date Apr. 24, 2024 (4/24/24) to illustrate that a post emergence herbicide application was conducted on Apr. 24, 2024.

Progress perspective data display element 502-2 comprises text “NPK 60 lbs/ac Aug. 1, 2024” and a line overlaying the graph 523 and disposed on the x-axis 528 at the interval representing the date Aug. 1, 2024 (8/1/24) to illustrate that, per an operational strategy 400, an application of NPK fertilizer product at 60 pounds an acre is scheduled to be conducted on Aug. 1, 2024. Progress perspective data display element 502-3 comprises text “Harvest Oct. 12, 2024” and a line overlaying the graph 523 and disposed the x-axis 528 at the interval representing the date Oct. 12, 2024 (10/12/24) to illustrate when progress prediction computing system 102 predicts harvest will occur.

Table 1 illustrates an example dialogue between a user 180 and progress prediction computing system (PPCS) 102 that may result in interface 514-1.

TABLE 1

[symbol]

[symbol]

indicates data missing or illegible when filed

USER: “I plan to conduct an NPK fertilizer application operation on Aug. 1, 2024 this season” (operational strategy 400) “show me when harvest will occur this season” (progress perspective selection 404).

PPCS: “Currently, harvest is predicted to occur on Oct. 12, 2024” (progress perspective data 450) “as shown in the provided user interface” (presentation 454).

FIG. 5B shows a pictorial illustration of one example user interface 514 (illustratively 514-2). Interface 514-2 includes all of the elements of interface 514-1 and thus, they are not again referenced in FIG. 5B. As can be seen in FIG. 5B, interface 514-2 includes an example recommended operational adjustment display element 504 (illustratively 504-1) and example progress perspective data display elements 502 (illustratively 502-4 and 502-5).

Recommended operation adjustment display element 504-1 comprises text “Irrigate 6 gpm/ac Aug. 2, 2024” and a line overlaying the graph 523 disposed the x-axis 528 at the interval representing the date Aug. 2, 2024 (8/2/24) to illustrate a timing for a recommended operation adjustment in the form of an added irrigation operation to apply water at 6 gallons per minute an acre.

Progress perspective data display element 502-4 comprises text “Harvest Oct. 7, 2024” and a line overlaying the graph 523 and disposed the x-axis 528 at the interval representing the date Oct. 7, 2024 (10/7/24) to illustrate when progress prediction computing system 102 predicts harvest will occur if the recommended operation adjustment is implemented.

Progress perspective display element 502-5 includes graph 523, y-axis 524, x-axis 528, and a line display element 546 that includes historical progress portion 532 and alternate predicted progress portion 548. Alternate predicted progress portion 548 illustrates an alternate predicted crop growth throughout a remainder of an alternate season (illustratively up to alternate harvest time on Oct. 7, 2024 (10/7/24)).

Table 2 illustrates a continuation of the dialogue from Table 1 between a user 180 and progress prediction computing system (PPCS) 102 that may result in interface 514-2.

TABLE 2

[symbol]

[symbol]

indicates data missing or illegible when filed

USER: “How” (operational strategy 400) “can I make harvest happen by Oct. 7, 2012” (progress perspective selection 404)?

PPCS: “Adding an irrigation operation of 6 gallons per minute an acre on Aug. 2, 2024, 24 hours after the planed fertilizer application on Aug. 1, 2024” (recommended operational adjustment 452) “is predicted to result in harvest occurring on Oct. 7, 2012” (progress perspective data 450 “as shown in the provided user interface” (presentation 454).

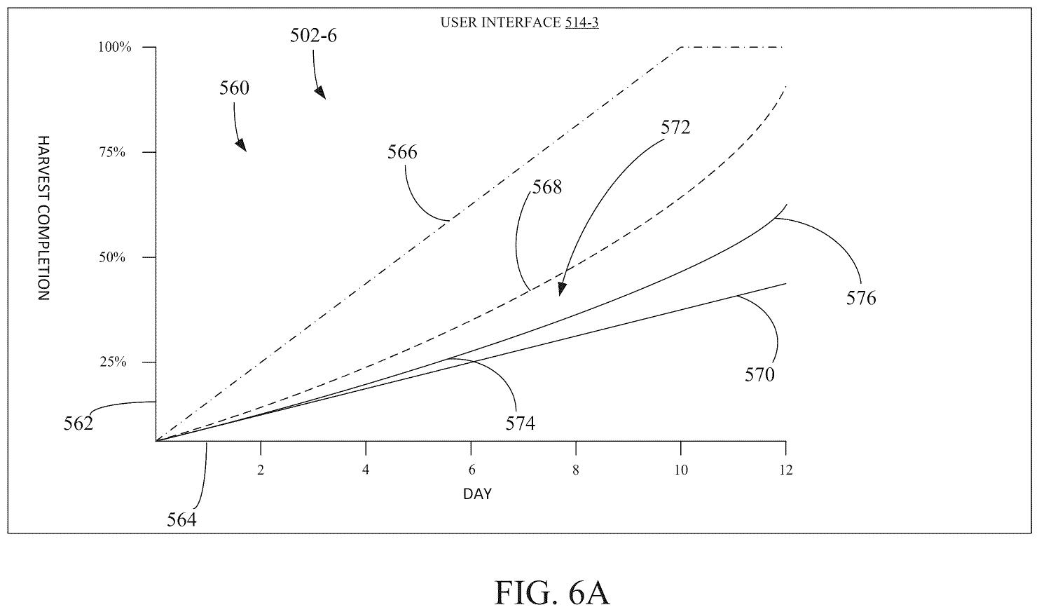

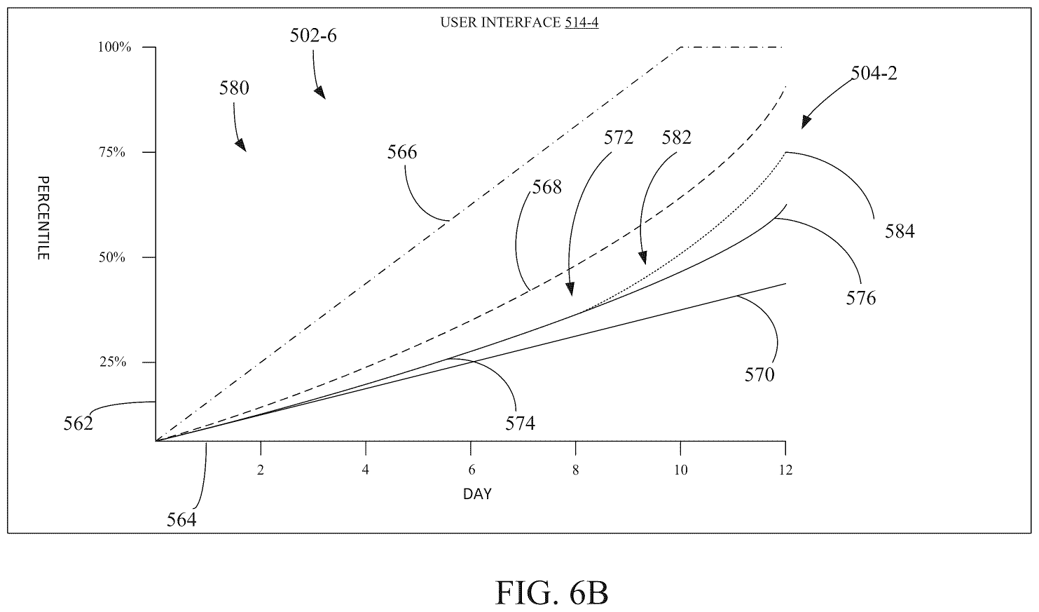

FIG. 6A shows a pictorial illustration of one example user interface 514 (illustratively 514-3). Interface 514-3 includes an example perspective data display element 502 (illustratively 502-6).

Generally, user interface 514-2 shows a historical and predicted progress of harvesting across a user's farm during a current season at multiple percentiles based on historical harvesting data 160 for the user's farm.

As illustrated in FIG. 6A, progress perspective data display element 502-6 comprises a graph 560. Graph 560 is a line graph. Progress perspective data display element 502-8 further includes a y-axis 562 that provides a harvest completion scale (a percentage of total area harvested scale) and an x-axis 564 that provides a time scale (illustratively with day intervals). Progress perspective data display element 502-6 further includes a line display element 566, a line display element 568, a line display element 570, and a line display element 572. Line display element 566 illustrates a predicted harvest completion across the time scale for a 100 percentile. Line display element 568 illustrates a predicted harvest completion across the time scale for 75 percentile. Line display element 570 illustrates a predicted harvest completion across the time scale for 25 percentile. Line display element 572 includes a historical portion 574 and a predicted portion 576. Historical portion 574 illustrates the historical harvest completion from the beginning of the harvesting to a current time (illustratively day 6). Predicted portion 576 illustrates a predicted harvest completion from a current time (illustratively day 6) to day 12.

Table 3 illustrates an example dialogue between a user 180 and progress prediction computing system (PPCS) 102 that may result in interface 514-3. It should be noted that the user is currently on day 6.

TABLE 3

[symbol]

[symbol]

indicates data missing or illegible when filed

USER: “Show me a harvest completion” (progress perspective selection 404) “over 12 days using my currently scheduled worker availability from when I began harvest” (operational strategy 400).

PPCS: “Predict a 100 percentile harvest completion at day 10, a 75 percentile harvest completion of 85% at day 12, and a 25 percentile harvest completion of 45% at day 12” (progress perspective data 450). “Currently you have a harvest completion of 25% and have a predicted completion of 60% at day 12” (progress perspective data 450) “as shown in the provided user interface” (presentation 454).

FIG. 6B shows a pictorial illustration of one example user interface 514 (illustratively 514-4). Interface 514-4 includes an example perspective data display element 502 (illustratively 502-7) and a recommend operational adjustment display element 504 (illustratively 504-2). Interface 514-4 is similar to interface 514-3 and thus, similar elements are numbered similarly.

As illustrated in FIG. 6B, progress perspective data display element 502-7 comprises a graph 580. Graph 580 is a line graph. Graph 580 is similar to graph 560 and similarly includes y-axis 562, x-axis 564, line display element 566, line display element 568, line display element 570, and line display element 572. However, graph 580 further includes a line display element 582 that includes historical portion 574 and alternate predictive portion 584. Alternate predictive portion 584 an alternate predicted harvest completion from a current time (illustratively day 6) to day 12 if the operational plan is changed to increase schedule work time by 4 hours each day. In the illustrated example, line element 582 alternate predictive portion 584 also serves as recommend operational adjustment display element 504-2.

Table 4 illustrates a continuation of the dialogue from Table 3 between a user 180 and progress prediction computing system (PPCS) 102 that may result in interface 514-4.

TABLE 4

[symbol]

[symbol]

indicates data missing or illegible when filed

USER: “How” (operational strategy 400) “can I increase my harvest completion by day 12” (progress perspective selection 404)?”

PPCS: “There are several things that can be done to improve harvest completion:” 1) Mannie implement has a larger capacity combine available for rent; 2) current availability data shows time that could be used to run existing equipment longer each day; 3) harvester speed could be increased by 2 miles per hour” (recommended operational adjustments 452).

USER: “Which option results in the most profit” (progress perspective selection 404).

PPCS: “Since the available farm labor are family members, the progress is achieved with zero labor cost and results in the most profit” (progress perspective data 450).

USER: “Show me” (output selection 406) “the option where work hours” (model selection 408) “are increased” (operational strategy 400).

PPCS: “Increasing work hours from day 6 is predicted to result in an increased harvest completion of 75%” (progress perspective data 450).

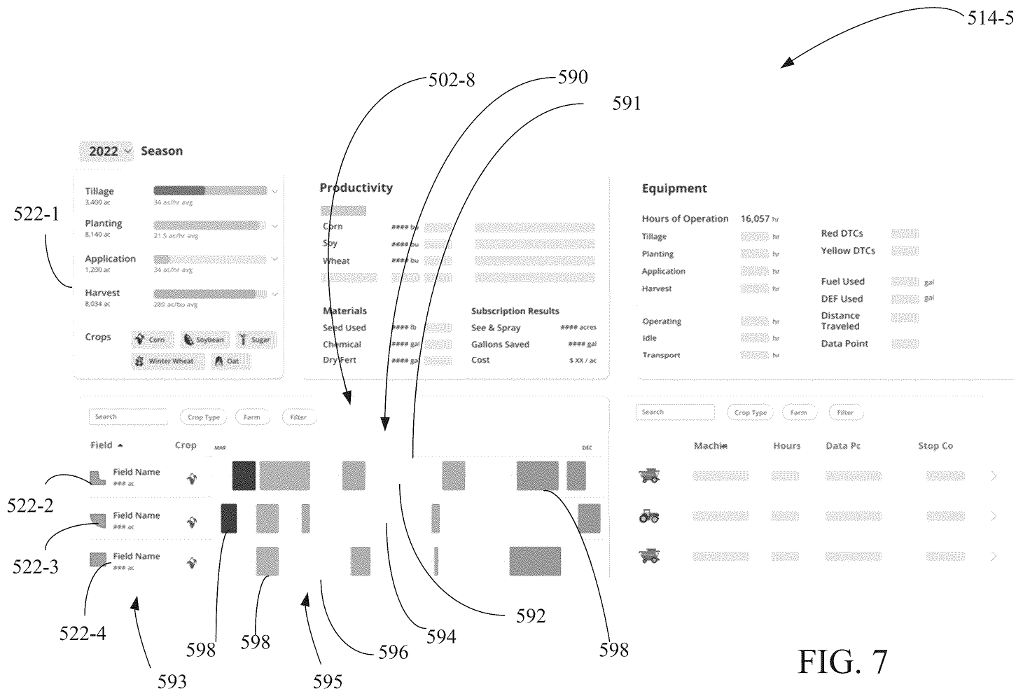

FIG. 7 is a pictorial illustration of one example user interface 514 (illustratively 514-5). Interface 514-5 includes example progress perspective data display element 502 (illustratively 502-8) and example other display elements 522 (illustratively 522-1, 522-2, 522-3, and 522-4).

Other data display element 522-1 illustratively comprises a legend that defines the operations to which bars 598 correspond. Other data display elements 522-2, 522-3, and 522-4 comprise worksite identifying information (text, numbers, and icon) that identifying the worksite that each row in the graphical table 590 corresponds to.

In the illustrated example, progress perspective data display element 502-8 comprises a table 590 having a time scale 591 extending from a beginning of a season (illustratively the beginning of March) to an end of the season (illustratively the end of December). Table 590 further includes 3 rows, 592, 594, and 596, and 2 columns, 593 and 595. Each row corresponds to a different worksite, as identified by other display elements 522-1, 522-2, and 522-3 in column 593. Column 595 that displays progress perspective data 504 for each worksite. Specifically, each row in column 595 includes one or more bars 598. Each bar 598 corresponds to a particular type of operation and, as shown, a given type of operation may occur more than once or otherwise be separated in time such that multiple bars 598 in a row may correspond to a same type of operation. Table 590 illustrates a predicted progression of a season across multiple worksites, including predicted progressions of each of multiple operations at each worksite during the season.

Table 5 illustrates an example dialogue between a user 180 and progress prediction computing system (PPCS) 102 that may result in interface 514-5.

TABLE 5

[symbol]

[symbol]

indicates data missing or illegible when filed

USER: “Show me” (output selection 406) “a season end date” (progress perspective selection 404) “for all of my worksites if I start tillage in in March” (operational strategy 400)”.

PPCS: “Your predicted season end date is December 26th, finishing at Field 2, with Field 1 finishing on December 8^{th}, and Field 4 finishing November 16^{th}” (progress perspective data 450) “as shown in the provided user interface” (presentation 454).

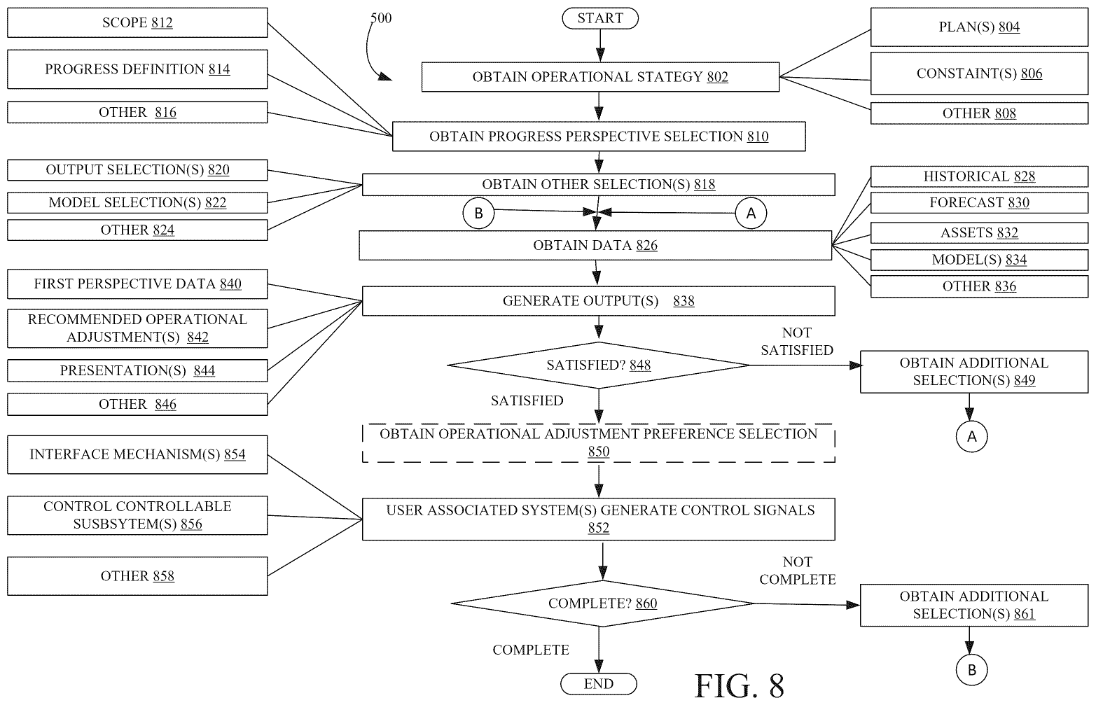

FIG. 8 shows a flow diagram illustrating one example operation 500 of agricultural computing system architecture 100.

At block 802, progress prediction computing system 102 obtains (e.g., receives or retrieves) a selection 190 including an operational strategy 400. As illustrated by block 804, operational strategy 400 can include plans 804. As illustrated by block 806, operational strategy can, alternatively or additionally, include constraints 806. As illustrated by block 808, operational strategy can, alternatively or additionally, include other items 424.

At block 810, progress prediction computing system 102 obtains a selection 190 including a progress perspective selection 404. As illustrated by block 812, progress perspective selection 404 can include scope 426. As illustrated by block 814, progress perspective selection 404 can, alternatively or additionally, include progress definition 428. As illustrated by block 816, progress perspective selection 404 can include other items 430.

At block 818, progress prediction computing system 102 can obtain selection(s) 190 including other items. As illustrated by block 820, the other items can include an output selection 406. As illustrated by block 822, other items can include, alternatively or additionally, a model selection 408. As illustrated by block 824, other items can include, alternatively or additionally, other selections 412.

It will be noted that a single selection 190 can provide all the items discussed at blocks 802, 810, and 818. In other examples, multiple selections 190 can provide the items discussed at blocks 802, 810, and 818 according to various distributions.

At block 826, progress prediction computing system 102 obtains various data based, at least in part, on the obtained selection(s) 190. The various data can include historical data 160, as indicated by block 828. The various data can include, alternatively or additionally, forecast data 162, as indicated by block 830. The various data can include, alternatively or additionally, assets data 164, as indicated by block 832. The various data can include, alternatively or additionally, one or more models 166, as indicated by block 834. The various data can include, alternatively or additionally, various other data 168, as indicated by block 836.

At block 838, progress prediction computing system 102 generates one or more outputs 195. The one or more outputs 195 can include progress perspective data 450, as indicated by block 840. The one or more outputs 195 can include, alternatively or additionally, one or more recommended operational adjustments 452, as indicated by block 842. The one or more outputs can include, alternatively or additionally, one or more data 453, as indicated by block 844. The one or more outputs 195 can include, alternatively or additionally, one or more presentations 454, as indicated by block 846.

At block 848 a user 180 or a user associated system, such as computing systems 300 or mobile work machines 200, determine if the one or more outputs 195 are satisfactory.

If, at block 848, it is determined that the one or more outputs 195 are not satisfactory, operation proceeds to block 849 where one or more additional (e.g., updated) selections 190 are obtained. The one or more additional selections 190 can include one or more of an additional operation strategy 400, an additional progress perspective selection 404, an additional output selection 406, an additional model selection 408, or various other additional selections 412. Processing then returns to block 826.

If, at block 848, it is determined that the one or more outputs 195 are satisfactory, operation proceeds to block 850 where, optionally, an operational adjustment preference selection 410 is obtained. An operational adjustment preference selection 410 might be obtained when the one or more outputs 195 include one or more recommended operational adjustments 452.

At block 852 one or more user associated system (e.g., remote computing systems 300 or mobile work machines 200, or both) generate control signals based on the one or more outputs 195, and, in some examples, based on the obtained operational adjustment preference selection 410. As indicated by block.

As indicated by block 854, remote computing systems 300 can generate control signals to control user interface mechanisms 304 to generate a presentation (e.g., display or audible, or both) to present the one or more outputs 195 (or information therein) to a user 180. Controlling a user interface mechanism 304 to generate a presentation can, in one example, include controlling a user interface mechanism 304 to generate a user interface display 314 (e.g., 514). Alternatively, or additionally, at block 854, mobile work machines 200 can generate control signals to control user interface mechanisms 204 to generate a presentation (e.g., display or audible, or both) to present the one or more outputs 195 (or information therein) to a user 180. Controlling a user interface mechanism 204 to generate a presentation can, in one example, include controlling a user interface mechanism 204 to generate a user interface display 214 (e.g., 514).

As indicated by block 856, mobile work machines 200 can generate control signals to control one or more controllable subsystems 516 based on the one or more outputs (or information therein) and, in some examples, an operational adjustment preference selection 410.

As indicated by block 858 user associated systems, such as remote computing systems 300 or mobile work machines 200, or both, can generate control signals to control various other items.

At block 860, it is determined if the operation 500 is complete. If it is determined that the operation is complete, then the operation ends. If it is determined that the operation is not complete, then the operation proceeds to block 861 where one or more additional (e.g., updated) selections 190 are obtained. The one or more additional selections 190 can include one or more of an additional operation strategy 400, an additional progress perspective selection 404, an additional output selection 406, an additional model selection 408, or various other additional selections 412. Processing then returns to block 826.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual (e.g., software) keyboard or other virtual (e.g., software) actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

Additionally, various models have been discussed. Model implementations may be mathematical, making use of mathematical equations, empirical correlations, statistics, tables, matrices, and the like. Other model implementations may rely more on symbols, knowledge bases, and logic such as rule-based systems. Some implementations are hybrid, utilizing both mathematics and logic. Some models may incorporate random, non-deterministic, or unpredictable elements. Some model implementations may make use of networks of data values such as neural networks. These are just some examples of models. Additionally, models may be generated in a variety of ways including with employment of artificial intelligence (e.g., machine learning, etc.) method, including, without limitation, memory networks, Bayes systems, decisions trees, Eigenvectors, Eigenvalues and Machine Learning, Evolutionary and Genetic Algorithms, Cluster Analysis, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning. Learning may be supervised or unsupervised.

A number of data stores have also been discussed. It will be noted the data stores can each be broken into multiple data stores. In some examples, one or more of the data stores May be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, modules, generators, components, and interactions. It will be appreciated that any or all of such systems, modules, generators, components, and interactions may be implemented by hardware items, such as one or more processors, one or more processors executing computer executable instructions stored in memory, memory, or other processing components, some of which are described below, that perform the functions associated with those systems, components, generators, or interactions. In addition, any or all of the systems, modules, generators, components, and interactions may be implemented by software that is loaded into a memory and is subsequently executed by one or more processors or one or more servers or other computing component(s), as described below. Any or all of the systems, modules, generators, components, and interactions may also be implemented by different combinations of hardware, software, firmware, etc., some examples of which are described below. These are some examples of different structures that May be used to implement any or all of the systems, modules, generators, components, and interactions described above. Other structures may be used as well.

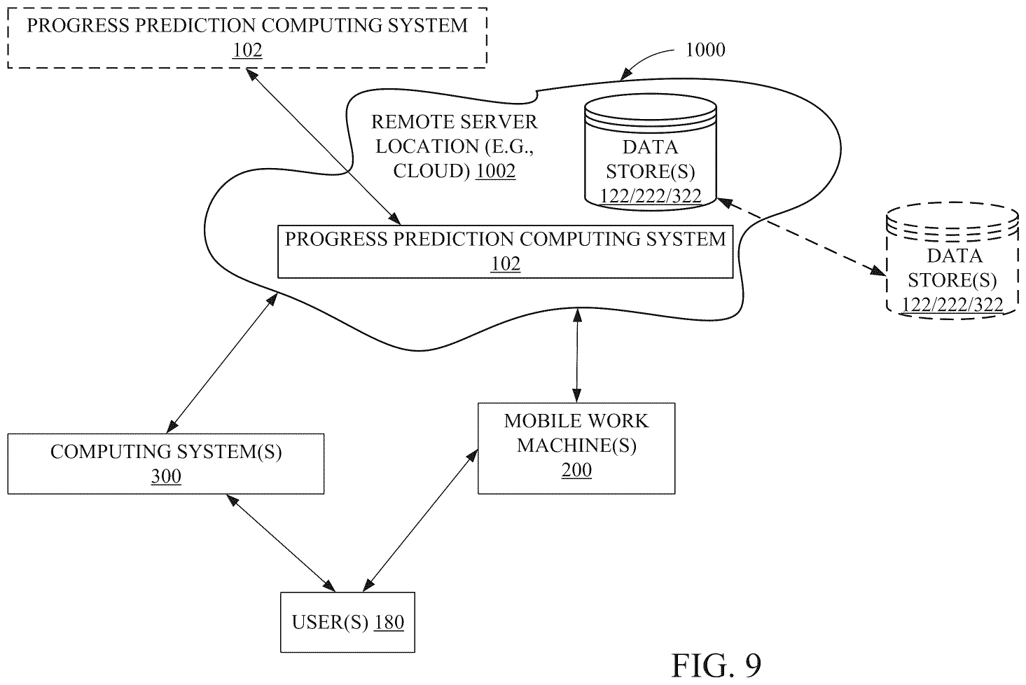

FIG. 9 is a block diagram of a remote server architecture 1000. FIG. 5, also shows one or more mobile work machines 200 and one or more computing systems 300 in communication with the remote server environment. The one or more mobile work machines 200 and one or more computing systems 300 communicate with elements in a remote server architecture 1000. In some examples, remote server architecture 1000 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in previous figures as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 9, some items are similar to those shown in previous figures and those items are similarly numbered. FIG. 9 specifically shows that progress prediction computing system 102 and one or more of data stores 104, 222, and 322, may be located at a server location 1002 that is remote from the one or more mobile work machines 200 and one or more computing systems 300. Therefore, in the example shown in FIG. 9, the one or more mobile work machines 200 and one or more computing systems 300 access systems through remote server location 1002. In other examples, various other items may also be located at server location 1002, such as various other items of agricultural computing system architecture 100.

FIG. 9 also depicts another example of a remote server architecture. FIG. 9 shows that some elements of previous figures may be disposed at a remote server location 1002 while others may be located elsewhere. By way of example, one or more of data store(s) 104, 222, and 322 may be disposed at a location separate from location 1002 and accessed via the remote server at location 1002. Similarly, progress prediction computing system 102 may be disposed at a location separate from location 1002 and accessed via the remote server at location 1002. Regardless of where the elements are located, the elements can be accessed directly by one or more mobile work machines 200 and one or more computing systems 300 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users, or systems. For instance, physical carriers may be used instead of, or in addition to, electromagnetic wave carriers. In some examples, where wireless telecommunication service coverage is poor or nonexistent, another machine, such as a fuel truck 17 or other mobile machine or vehicle, may have an automated, semi-automated or manual information collection system. As a mobile machine (e.g., mobile awork machine 200) comes close to the machine containing the information collection system, such as a fuel truck prior to fueling, the information collection system collects the information from the mobile machine using any type of ad-hoc wireless connection. The collected information may then be forwarded to another network when the machine containing the received information reaches a location where wireless telecommunication service coverage or other wireless coverage is available. For instance, a fuel truck may enter an area having wireless communication coverage when traveling to a location to fuel other machines or when at a main fuel storage location. All of these architectures are contemplated herein. Further, the information may be stored on a mobile machine until the mobile machine enters an area having wireless communication coverage. The mobile machine, itself, May send the information to another network.

It will also be noted that the elements of previous figures, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

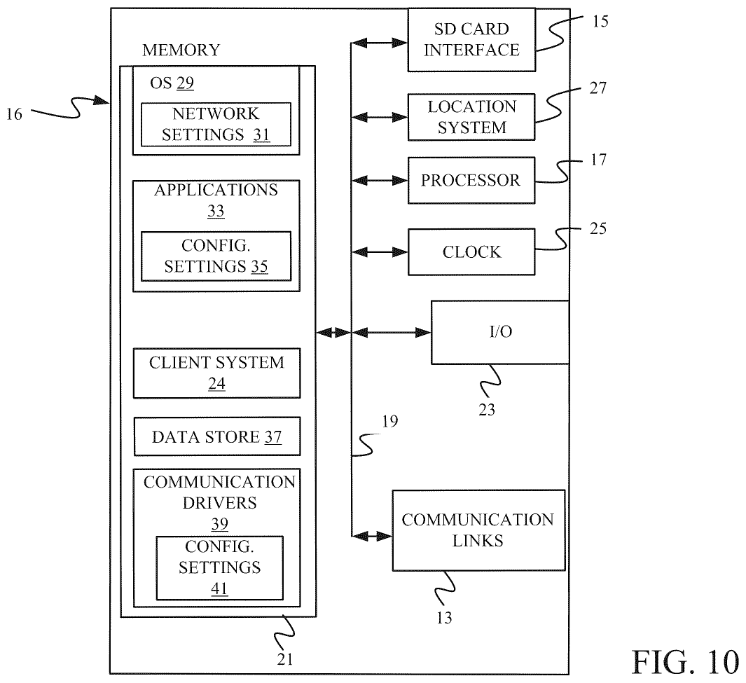

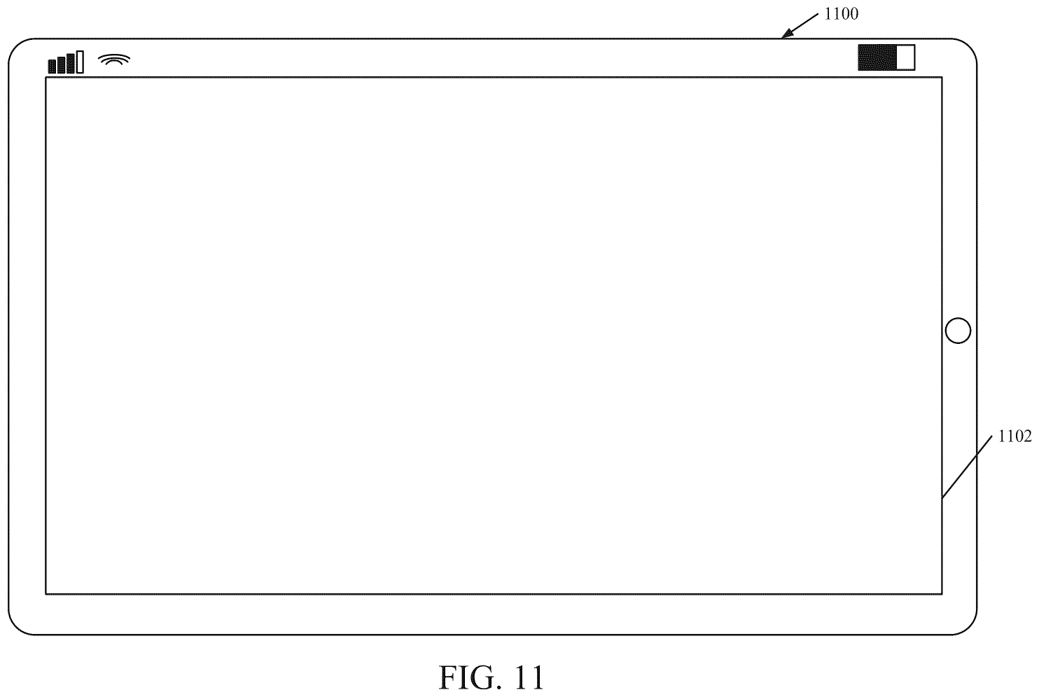

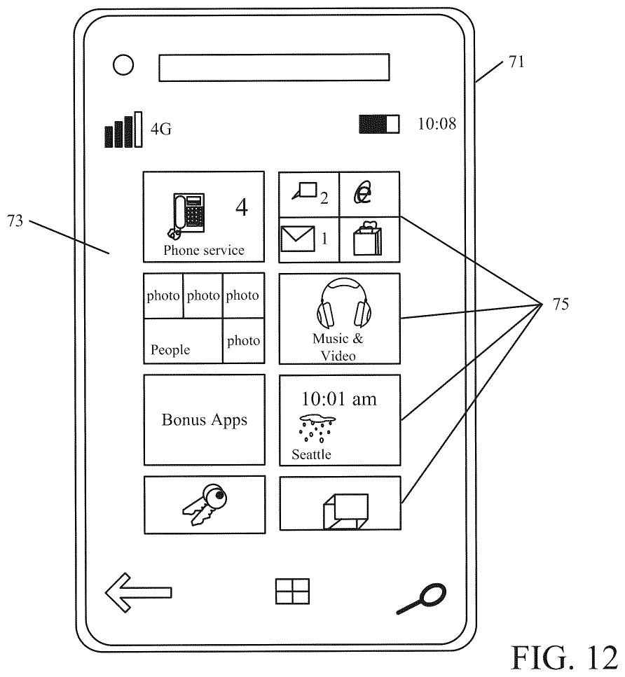

FIG. 10 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., a mobile work machine 200) for use in interacting with query execution computing system 102 or for use in executing functionality of progress prediction computing system 102. In another example, a mobile device can be used as a computing system 300 for use in interacting with progress prediction computing system 102 or for use in executing functionality of progress prediction computing system 102. FIGS. 11-12 are examples of handheld or mobile devices.

FIG. 10 provides a general block diagram of the components of a client device 16 that can run some components shown in previous figures, that interact with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, client system 24, communication drivers 39, and communication configuration settings 41. Memory 21 can include all types of tangible volatile and non-volatile computer-readable memory devices. Memory 21 may also include computer storage media (described below). Memory 21 stores computer readable instructions that, when executed by processor 17, cause the processor to perform computer-implemented steps or functions according to the instructions. Processor 17 may be activated by other components to facilitate their functionality as well.

FIG. 11 shows one example in which device 16 is a tablet computer 1100. In FIG. 11, computer 1100 is shown with user interface display screen 1102. Screen 1102 can be a touch screen or a pen-enabled interface that receives inputs from a pen or stylus. Tablet computer 1100, May also use an on-screen virtual keyboard. Of course, computer 1100 might also be attached to a keyboard or other user input device through a suitable attachment mechanism, such as a wireless link or USB port, for instance. Computer 1100 may also illustratively receive voice inputs as well.

FIG. 12 is similar to FIG. 11 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

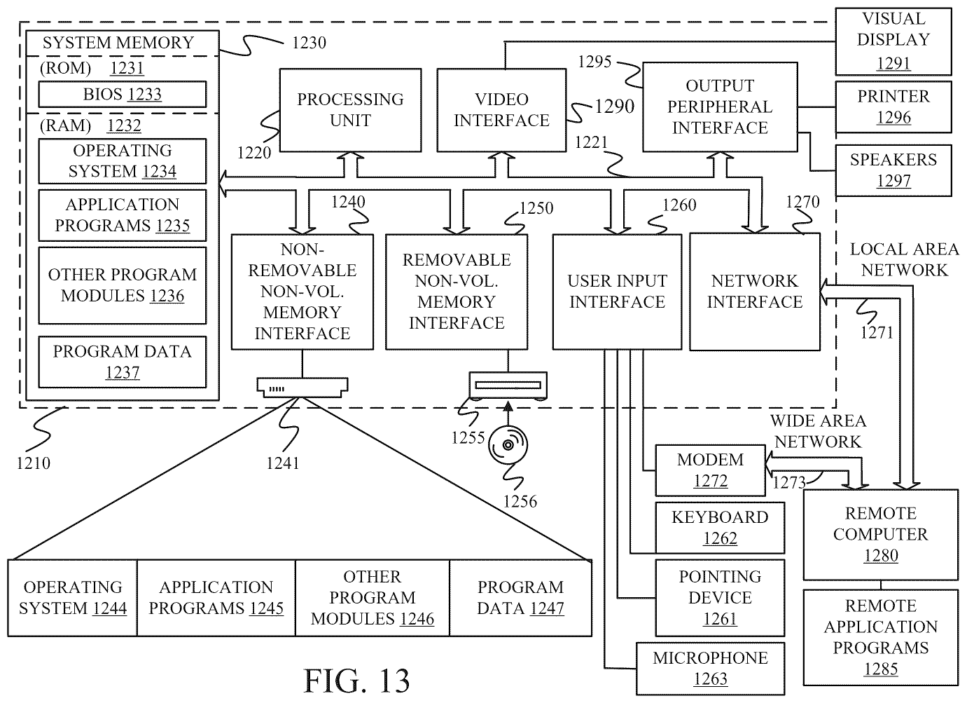

FIG. 13 is one example of a computing environment in which elements of previous figures described herein can be deployed. With reference to FIG. 13, an example system for implementing some embodiments includes a computing device in the form of a computer 1210 programmed to operate as discussed above. Components of computer 1210 may include, but are not limited to, a processing unit 1220 (which can comprise processors or servers from previous figures), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to previous figures described herein can be deployed in corresponding portions of FIG. 13.

Computer 1210 typically includes a variety of computer readable media. Computer readable media may be any available media that can be accessed by computer 1210 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 13 illustrates operating system 1234, application programs 1235, other program modules 1236, and program data 1237.

The computer 1210 may also include other removable/non-removable volatile/nonvolatile computer storage media. By way of example only, FIG. 13 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 13, provide storage of computer readable instructions, data structures, program modules and other data for the computer 1210. In FIG. 13, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite dish, scanner, or the like. These and other input devices are often connected to the processing unit through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections (such as a controller area network—CAN, local area network—LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 13 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

What is claimed is:

1. A computer implemented method of controlling a user associated system, the computer implemented method comprising:
obtaining a first operational strategy input identifying a first operational strategy;
obtaining a first progress perspective selection input identifying a first progress perspective selection;
obtaining historical data;
obtaining forecast data;
generating a first output including first performance perspective data based on the historical data, the forecast data, the first operational strategy input, and the first progress perspective selection; and
generating a control signal to control the user associated system based on the first output.

2. The computer implemented method of claim 1, wherein generating the control signal to control the user associated system comprises controlling an interface mechanism of the user associated system to provide a presentation indicative of the first performance perspective data.

3. The computer implemented method of claim 1, wherein generating the control signal to control the user associated system comprises controlling, as the user associated system, a mobile work machine.

4. The computer implemented method of claim 1 and further comprising:
obtaining a second operational strategy input identifying a second operational strategy; and
generating a second output including second performance perspective data based on the second optional strategy.

5. The computer implemented method of claim 1 and further comprising:
obtaining a second progress perspective selection input identifying a second progress perspective selection; and
generating a second output including second performance perspective data based on the second progress perspective selection.

6. The computer implemented method of claim 1 and further comprising generating a recommended operational adjustment indicative of a recommended adjustment to the first operational strategy.

7. The computer implemented method of claim 6, and further comprising:
obtaining an operational adjustment preference selection input indicative of an operation adjustment preference selection; and
generating the control signal based further on the operational adjustment preference selection.

8. The computer implemented method of claim 1 and further comprising:
obtaining assets data; and
generating the first output including first progress perspective data based further on the assets data.

9. The computer implemented method of claim 1 and further comprising:
obtaining one or more of a model selection input indicative of a model selection and an output selection input indicative of an output selection; and
generating the first output including the first progress perspective data based further on the one or more of the model selection and the output selection.

10. An operations computing system comprising:
one or more processors;
memory; and
computer executable instructions stored in the memory, the computer executable instructions, when executed by the one or more processors, configuring the one or more processors to:
obtain a first operational strategy input identifying a first operational strategy;
obtain a first progress perspective selection input identifying a first progress perspective selection;
obtain historical data;
obtain forecast data;
generate a first output including first performance perspective data based on the historical data, the forecast data, the first operational strategy, and the first progress perspective selection; and
generate a control signal to control the user associated system based on the first output.

11. The operations computing system of claim 10, wherein the control signal is configured to control an interface mechanism of a user associated system to provide a presentation indicative of the first performance perspective data.

12. The operations computing system of claim 10, the control signal is configured to control, as a user associated system, a mobile work machine.

13. The operations computing system of claim 10, wherein the computer executable instructions, when executed by the one or more processors, further configure the one or more processors to:
obtain a second operational strategy input identifying a second operational strategy; and
generate a second output including second performance perspective data based on the second operational strategy.

14. The operations computing system of claim 10, wherein the computer executable instructions, when executed by the one or more processors, further configure the one or more processors to:
obtain a second progress perspective selection input identifying a second progress perspective selection; and
generate a second output including second performance perspective data based on the second progress perspective selection.

15. The operations computing system of claim 10 wherein the computer executable instructions, when executed by the one or more processors, further configure the one or more processors to:
generate a recommended operational adjustment indicative of a recommended adjustment to the first operational strategy.

16. The operations computing system of claim 15 wherein the computer executable instructions, when executed by the one or more processors, further configure the one or more processors to:
obtain an operational adjustment preference selection input indicative of an operation adjustment preference selection; and
generate the control signal based further on the operational adjustment preference selection.

17. The computer implemented method of claim 10, wherein the computer executable instructions, when executed by the one or more processors, further configure the one or more processors to:
obtain assets data; and
generate the first output including first progress perspective data based further on the assets data.

18. The computer implemented method of claim 10, wherein the computer executable instructions, when executed by the one or more processors, further configure the one or more processors to:
obtain one or more of a model selection input indicative of a model selection and an output selection input indicative of an output selection; and
generate the first output including the first progress perspective data based further on the one or more of the model selection and the output selection.

19. A computer implemented method of controlling a user associated system, the computer implemented method comprising:
obtaining a first operational strategy input identifying a first operational strategy and including a plan and a constraint;
obtaining a first progress perspective selection input identifying a first progress perspective selection and including a scope and a progress definition;
obtaining historical data;
obtaining forecast data;
generating a first output including first performance perspective data based on the historical data, the forecast data, the first operational strategy, and the first progress perspective selection;
generating a control signal to control the user associated system based on the first output;
obtaining a second operational strategy input identifying a second operational strategy;
obtaining a second progress perspective selection input identifying a second progress perspective selection;
generating a second output including second performance perspective data based on the second operational strategy and the second progress perspective selection; and
generating an additional control signal to control the user associated system based on the second output.

20. The computer implemented method of claim 19, wherein generating the control signal to control the user associated system comprises one of:
generating the control signal to control an interface mechanism of the user associated system to provide a presentation indicative of the first performance perspective data; or
generating the control signal to control, as the user associated system, a mobile work machine.
